(19) United States
(12) Patent Application Publication
(10) Pub. No.: US 2013/0028459 A1
(43) Pub. Date: Jan. 31, 2013

(54) Monolithic Silicon Microphone

(71) Applicant: Yunlong Wang, San Ramon, CA (US)

(72) Inventor: Yunlong Wang, San Ramon, CA (US)

(21) Appl. No.: 13/170,151

(22) Filed: Jul. 28, 2011

(51) Int. Cl. H04R 17/02

(52) U.S. Cl. 381/369

(57) ABSTRACT

A monolithic silicon microphone including a first backplate, a second backplate and a diaphragm displaced between said first backplate and said second backplate. Said first backplate is supported by a silicon substrate with one or more perforation holes. Said second substrate is attached to a perforated plate which itself is supported on said substrate. Said monolithic silicon microphone has integrated signal conditioning circuit, and is said diaphragm, said first backplate, said second backplate, and said signal conditioning circuit are electrically interconnected. Signals from said diaphragm, said first backplate, and said second backplate are fed into said signal conditioning circuit, and are amplified differentially.

### CROSS REFERENCE TO RELATED APPLICATION

U.S. Pat. Nos. 5,146,435; 5,452,268; 5,619,476; 5,870,351; 5,894,452; 6,493,288; 6,535,460; 6,847,090; 6,870,937; 7,166,910; 7,202,101; 7,221,767; 2007/0278601.

### BACKGROUND OF THE INVENTION

The batch processing of micromachining has led to the emergence of capacitive micromachined transducers. These transducers offer a larger set of parameters for optimization of performance as well as ease of fabrication and electronic integration. The fabrication and operation of micromachined transducers have been described in many publications and patents. For example, U.S. Pat. Nos. 5,619,476, 5,870,351, 5,894,452 and 6,493,288 describe the fabrication of capacitive-type ultrasonic transducers. U.S. Pat. Nos. 5,146,435; 5452,268, and 6,870,937 also describe micromachined capacitive transducers that are mainly used in the audio range for sound pickups. In most structures, the movable diaphragm of a micromachined transducer is either supported by a substrate or insulative supports such as silicon nitride, silicon oxide and polyamide. The supports engage the edge of membrane, and a voltage is applied between the substrate and a conductive film on the surface of the membrane causes the membrane to vibrate in response to the passing sound waves. In one particular case as described in the U.S. Pat. No. 6,535,460, the diaphragm is suspended to allow it rest freely on the support rings.

Many micromachined condenser microphones use a similar membrane structure to that of large measurement microphones and studio recording microphones. One common structure, shown in FIG. 1, consists of a conductive membrane 3 suspended over a conductive backplate 2 that is perforated with acoustic holes 4. The membrane 3 is supported by insulative piers 5 to keep a predetermined distance from the backplate 2. The backplate 2 itself is supported on a silicon substrate 1. Sound detection is possible when the impinging pressure wave vibrates the membrane 3, thus changing the capacitance of the transducer. Under normal operation, the change in capacitance of the condenser microphone die 10 is detected by measuring the output current under constant-voltage bias. Acoustic holes 4 are also used to equalize the pressure in the back chamber 6 to the ambient pressure to prevent fluctuations in atmospheric pressure from collapsing the membrane 3 against the backplate 2. The micromachined microphones are typically attached to a PCB board 8 to seal the back chamber of 6.

In actual applications, the microphone die 10 will need to be packaged into an environmentally protective enclosure such that it can be put into the electronic devices such as cell phones. There are many publications dealing with this type of packaging scheme. For example, U.S. Pat. No. 6,781,231 to Minervini, et al. discloses a microelectromechanical system package having a microelectromechanical system microphone, a substrate, and a cover. The substrate has a surface for supporting the microelectromechanical microphone. The cover includes a conductive layer having a center portion bounded by a peripheral edge portion. A housing is formed by connecting the peripheral edge portion of the cover to the substrate. The center portion of the cover is spaced from the surface of the substrate to accommodate the microelectromechanical system microphone. The housing includes an acoustic port for allowing an acoustic signal to reach the microelectromechanical system microphone.

U.S. Pat. No. 7,166,910 to Minervini et al. discloses a silicon condenser microphone package. The silicon condenser microphone package comprises a transducer unit, a substrate, and a cover. The substrate includes an upper surface having a recess formed therein. The transducer unit is attached to the upper surface of the substrate and overlaps at least a portion of the recess wherein a back volume of the transducer unit is formed between the transducer unit and the substrate. The cover is placed over the transducer unit and includes an aperture.

The typical layout of this type of packaging is shown in FIG. 2. Where the micromachined microphone die 10 is attached to a PCB board 8. Also attached to the PCB board 8 is an ASIC die 14. Wire bond 15 is used to establish the electrical connection between ASIC 14 and microphone die 10. A mechanical cavity 16 is formed with housing wall 11 and cover 12. There is an acoustic hole 13 on the housing cover 12 to allow the passage of acoustic signal to the microphone die 10. Conductive pads 17 are attached to the backside of PCB board 8 such that the packaged microphone as shown in FIG. 2 can be surface mounted to the main board of an electronic device.

According to the teachings of U.S. Pat. Nos. 6,781,231 and 7,166,910, housing wall 11 and cover 12 are themselves conductive or have conductive layers in between such that an electromagnetic shielding is formed to protect the microphone die from picking up electromagnetic interferences. The housing wall 11 and cover 12 form a complete grounding circuit with ground electrode in PCB 8.

U.S. Pat. No. 7,221,767 to Mullenborn, et al. discloses a surface mountable acoustic transducer system, comprising one or more transducers, a processing circuit electrically connected to the one or more transducers, and contact points arranged on an exterior surface part of the transducer system. The contact points are adapted to establish electrical connections between the transducer system and an external substrate, the contact points further being adapted to facilitate mounting of the transducer system on the external substrate by conventional surface mounting techniques. In this particular acoustic transducer system, as shown in FIG. 3, a microphone die 10 is adapted to a silicon carrier substrate 20 through solder seal ring 19. An ASIC die 14 is adapted to the same silicon carrier substrate 20 by solder bump 18. A lid 12 covers both microphone die 10 and ASIC die 14. One or multiple acoustic holes 13 is open on the lid 12 to allow the passage of acoustic signal to microphone die 10. Flip chip bonds 17 are attached at the bottom of carrier silicon substrate 17 such that the packaged acoustic transducer system is surface mountable to the main board of an electronic device.

The above publications teach what is referred to as a “two-chip” solution to make a completely packaged silicon microphone. As we can see from these publications, this solution requires both a micromachined microphone die and an ASIC die that is used for conditioning the signal from the microphone die. Both microphone die and ASIC die are packaged into a mechanical housing to protect them from environment, and for final operation.

There also examples of an integrated solution, where the microphone die and ASIC die are combined into one signal micromachined die. U.S. Pat. No. 7,202,101 to Gabriel et al. discloses a structure comprised of alternating layers of metal and sacrificial material built up using standard CMOS processing techniques, a process for building such a structure, a process for fabricating devices from such a structure, and the devices fabricated from such a structure. In one embodiment, a first metal layer is carried by a substrate. A first sacrificial layer is carried by the first metal layer. A second metal layer is carried by the sacrificial layer. The second metal layer has a portion forming a micro-machined metal mesh. When the portion of the first sacrificial layer in the area of the micro-machined metal mesh is removed, the micro-machined metal mesh is released and suspended above the first metal layer a height determined by the thickness of the first sacrificial layer. The structure may be varied by providing a base layer of sacrificial material between the surface of the substrate and the first metal layer. In that manner, a portion of the first metal layer may form a micro-machined mesh which is released when a portion of the base sacrificial layer in the area of the micro-machined mesh is removed. Additionally, a second layer of sacrificial material and a third metal layer may be provided. A micro-machined mesh may be formed in a portion of the third metal layer. The structure may be used to construct variable capacitors, switches and, when certain of the meshes are sealed, microspeakers and microphones.

Although this teaching successfully combines the microphone die and the ASIC die, a packaging scheme similar to that shown in FIG. 2 is required to make the final microphone unit that can be surface mounted for the end electronic device. As described in US publication No. 2007/0278601, the MEMS device includes a chip carrier having an acoustic port extending from a first surface to a second surface of the chip carrier, a MEMS die disposed on the chip carrier to cover the acoustic port at the first surface of the chip carrier, and an enclosure bonded to the chip carrier and encapsulating the MEMS die.

In all above mentioned publications, a complicated die-level packaging scheme is required. This packaging scheme involves the need to create an electrically connected enclosure to serve the purposes of environment protection and the shielding of electromagnetic interferences. This type of packaging scheme is not only time consuming, it also involves expensive equipments for performing post processing of silicon wafers. The need of said electrically connected enclosure also limits the size of microphone, making it difficult to be displaced anywhere in the end device system.

### SUMMARY OF THE INVENTION

It is an object of the present invention to provide a monolithic silicon microphone with integrated micromachined capacitive sensing element for sensing acoustic waves.

It is a further object of the present invention to provide a monolithic silicon microphone with integrated electronics to condition the sensed acoustic waves by said integrated micromachined capacitive sensing element.

It is another object of the present invention to provide a monolithic silicon microphone with integrated micromachined capacitive sensing element and conditioning electronics that is immune to the environmental factors.

It is a further object of the present invention to provide a monolithic silicon microphone with integrated micromachined capacitive sensing element and conditioning electronics that is immune to electromagnetic interferences.

It is another object of the present invention to provide a monolithic silicon microphone with integrated micromachined capacitive sensing element and conditioning electronics that has a movable diaphragm whereas the diaphragm vibrates in response to the impinging acoustic pressure.

It is a further object of the present invention to provide a monolithic silicon microphone with integrated micromachined capacitive sensing element and conditioning electronics that has two backplates.

It is another object of the present invention to provide a monolithic silicon microphone with integrated micromachined capacitive sensing element and conditioning electronics whereas said diaphragm is displaced between said two backplates. Said diaphragm is supported above one of said backplates.

It is a further object of the present invention to provide a monolithic silicon microphone with integrated micromachined capacitive sensing element and conditioning electronics whereas said conditioning electronics processes differential inputs from said micromachined capacitive sensing element.

The foregoing and other objects of the invention are achieved by a monolithic silicon microphone including a diaphragm displaced between two opposing backplates. A first backplate is supported by the silicon substrate, and a second backplate is suspended above said diaphragm. The suspension for said second backplate also forms an enclosure for said micromachined silicon sensing elements. Said diaphragm is supported by said first backplate. Said first and second backplates have perforation holes allowing the passage of acoustic pressure wave. Said diaphragm forms a first capacitor with said first backplate, and said diaphragm forms a second capacitor with said second backplate. The capacitances of said first and said second capacitors vary with the movement of said diaphragm responsive to the acoustic wave. Said monolithic silicon microphone has integrated signal conditioning electronics. Whereas the capacitance changes from said first and second capacitors are fed into the differential inputs of said signal conditioning electronics.

### BRIEF DESCRIPTION OF THE DRAWINGS

The foregoing and other objects of the invention will be more clearly understood from the following description when read in conjunction with the accompanying drawings of which:

FIG. 1 is a cross-sectional view of a prior art micromachined silicon microphone.

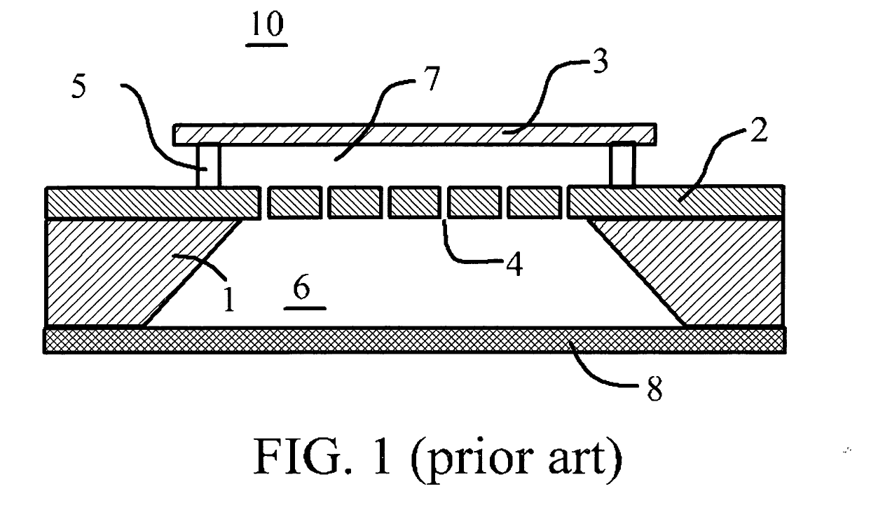

FIG. 2 shows a cross-sectional view of a prior art packaged micromachined silicon microphone.

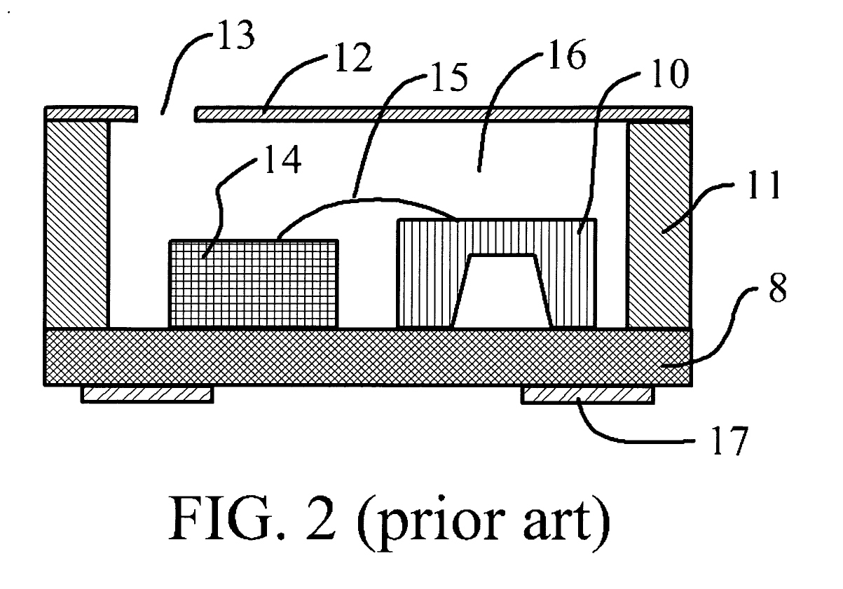

FIG. 3 shows a cross-sectional view of another prior art packaged micromachined silicon microphone.

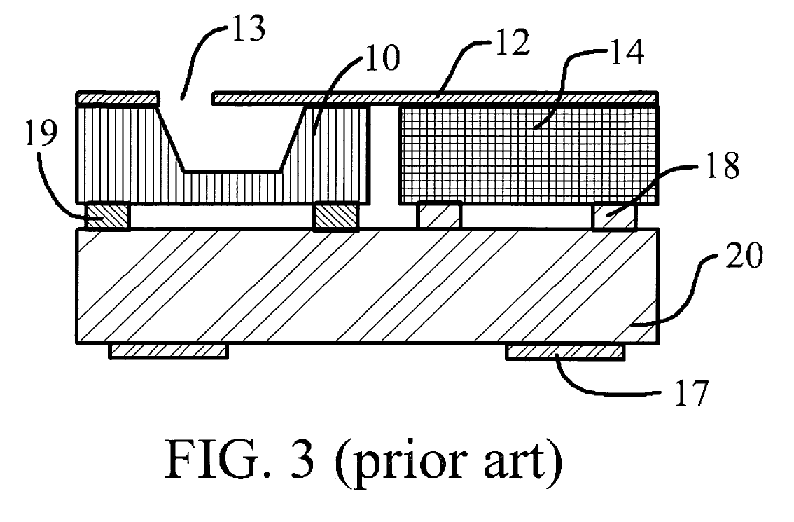

FIG. 4 shows a schematic drawing of a silicon microphone.

FIG. 5 shows a schematic drawing of a dual backplate silicon microphone.

FIG. 6 shows a cross sectional view of monolithic silicon microphone according to the first preferred embodiment of present invention.

FIG. 7 shows a cross sectional view of monolithic silicon microphone according to the second preferred embodiment of present invention.

FIG. 8 shows a cross sectional view of monolithic silicon microphone according to the third preferred embodiment of present invention.

FIG. 9 shows a cross sectional view of monolithic silicon microphone according to the fourth preferred embodiment of present invention.

### DESCRIPTION OF THE PREFERRED EMBODIMENTS

Cellular telephones typically have a microphone and associated circuitry to convert sound waves into an electronic signal for transmission to another telephone. The circuitry modulates a high frequency radio-frequency (“RF”) carrier signal (e.g., 1 to 2 GHz) with the microphone signal and transmits this modulated carrier signal via an antenna on the telephone. This modulated RF carrier signal is received by a base station (“a cell”) and forwarded to another telephone.

A cellular telephone typically comprises many physical components packed into a small physical space. Consequently, electromagnetic energy may escape from some of these components and couple into other cellular telephone components, thereby causing noise interference. (Of particular concern is the energy emitted from the telephone's antenna.) Pickup of noise signals at audio frequencies is particularly troublesome because these noise signals can interfere with the operation of the loudspeaker or microphone. This audio interference can adversely affect the operation of the cellular telephone. A particular problem is the audio interference signal that may be induced by time division interleaving of transmitter signals with receiver signals in the telephone. Such interleaving can be performed by the receiver de-interleave circuit and in the transmitter interleave circuit. For example, transmitter and receiver RF carrier signal interleaving is performed at a 217 Hz rate in a Time Division Multiple Access (“TDMA”) transmitter/receiver of a Global System for Mobile Communications (“GSM”) mobile telephone. Non-linear circuit elements in a cellular telephone can convert the turn-on and turn-off of the telephone's RF carrier for transmission at the 217 Hz rate into an audio interference signal at 217 Hz. Audio signal noise at this frequency resembles the sound of a bumblebee and is thus known as “bumblebee noise.” Such bumblebee noise can impact the ability of a cellular telephone to function as a voice communication device.

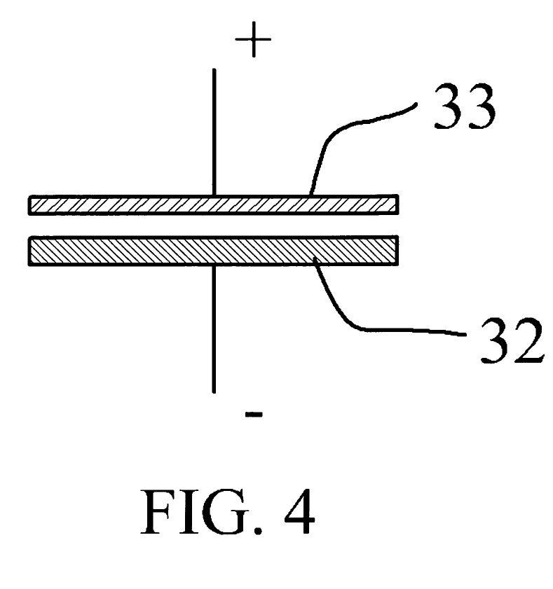

The bumblebee noise is transmitted through the electromagnetic coupling to the receiving microphone. In operation, a microphone resembles a variable capacitor with antenna. Refer to FIG. 4 now. This is a schematic drawing of a simplified silicon capacitive microphone. The microphone has a backplate 32 and a diaphragm 33. In operation, a bias voltage is applied to the microphone. Assuming the diaphragm 33 is connected to the positive lead of bias, and backplate 32 is connected to the negative lead of bias, as shown in FIG. 4. When acoustic pressure wave is impinging on the microphone, the diaphragm 33 will deflect up and down in response to the pressure wave, thus changing the capacitance of the capacitor. At the same time, this microphone structure also acts as an antenna to pick the electromagnetic coupling. The antenna length depends on the physical structure of the microphone, e.g., the physical size of diaphragm 33 and backplate 32. When the diaphragm 33 deflects up and down, its physical size changes very little. And therefore, the electromagnetic coupling to the microphone is considered as a constant number.

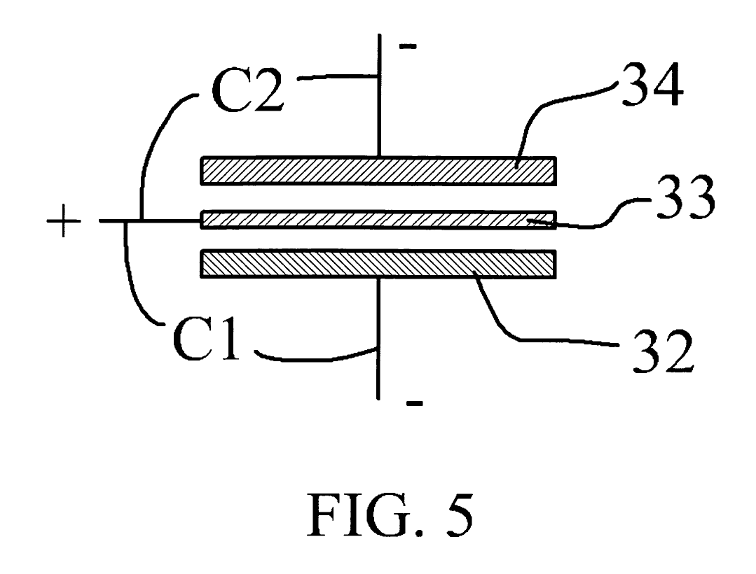

We now refer to FIG. 5. This is a schematic of a microphone with two backplates. The diaphragm 33 is sandwiched between a first backplate 32 and a second backplate 34. A capacitor C1 is formed by the diaphragm 33 and the first backplate 32. Similarly, a second capacitor C2 is formed by the diaphragm 33 and the second backplate 34. When the acoustic pressure wave impinges on the diaphragm 33, it deflects up and down. For the purpose of analysis, we assume the diaphragm deflects down, thus the capacitance C1 increases by an amount q and the capacitance C2 decreases by an amount q. The coupled electromagnetic signal, however, remains pretty much the same on both C1 and C2. When C1 and C2 signals are fed into the signal conditioning circuit as differential inputs, the electromagnetic portion of the C1 and C2 will be canceled out as the common mode, while the capacitance change due to acoustic pressure wave will be doubled.

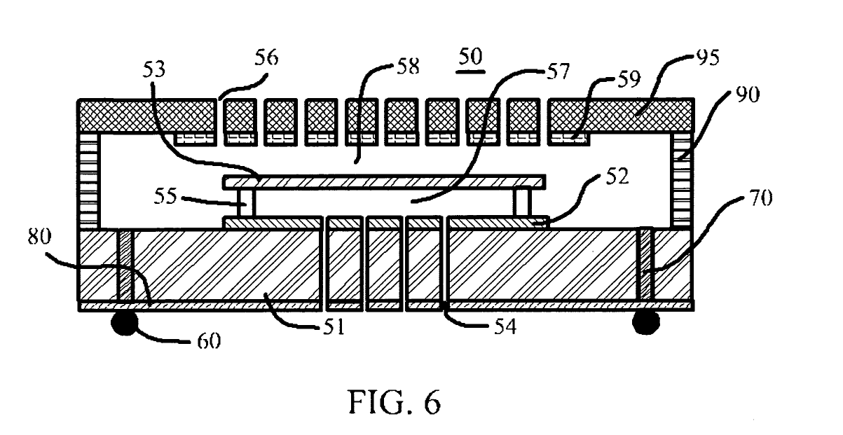

We now refer to the first embodiment according to the present invention. As shown in FIG. 6, the monolithic silicon microphone 50 has silicon substrate 51. A first backplate 52 is on and supported by said silicon substrate 51. A diaphragm 53 is suspended on top of said first backplate 52, and keeps a predetermined separation from said first backplate 52 by using supports 55. Diaphragm 53 and first backplate 52 forms a cavity 57. Both substrate 51 and first backplate 52 have perforation holes 54.

The substrate 51 also supports spacers 90, which themselves support a perforated plate 95. The perforated plate 95 is itself non-conductive, but it has a second backplate 59 on one of its sides. The spacers 90 keep the perforated plate 95 a predetermined separation from the diaphragm 53 such that the separation of diaphragm 53 from the first backplate 52 is similar to the separation of diaphragm 53 from the second backplate 59. A second cavity 58 is thus formed between the diaphragm 53 and the second backplate 59. Perforated plate 95 has perforation holes 56 such that acoustic signals can pass through the perforation holes 56 to impinge onto the diaphragm 53.

The signal conditioning electronics 80 is located at the other side of silicon substrate 51. Through wafer via 70 is used to establish electrical connection between the diaphragm 53, the first backplate 52, the second backplate 54 and signal conditioning circuit 80. Solder bumps 60 are attached to the surface of silicon substrate 51 where the signal conditioning circuit 80 is located.

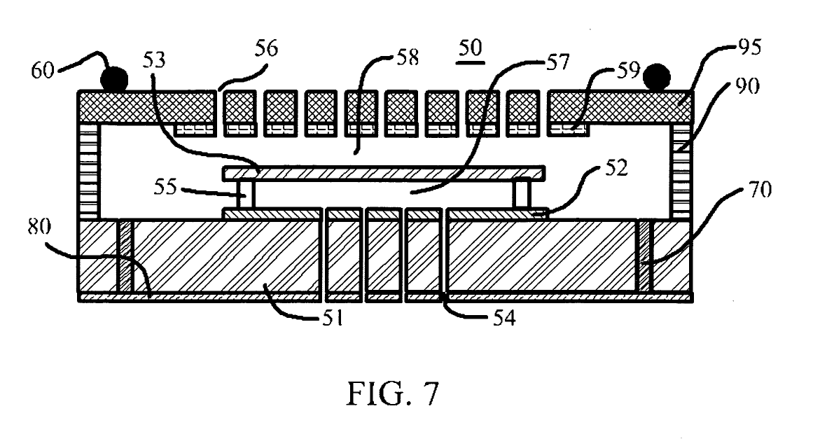

In a second preferred embodiment according to the present invention as shown in FIG. 7, the monolithic silicon microphone 50 has silicon substrate 51. A first backplate 52 is on and supported by said silicon substrate 51. A diaphragm 53 is suspended on top of said first backplate 52, and keeps a predetermined separation from said first backplate 52 by using supports 55. Diaphragm 53 and first backplate 52 forms a cavity 57. Both substrate 51 and first backplate 52 have perforation holes 54.

The substrate 51 also supports spacers 90, which themselves support a perforated plate 95. The perforated plate 95 is itself non-conductive, but it has a second backplate 59 on one of its sides. The spacers 90 keep the perforated plate 95 a predetermined separation from the diaphragm 53 such that the separation of diaphragm 53 from the first backplate 52 is similar to the separation of diaphragm 53 from the second backplate 59. A second cavity 58 is thus formed between the diaphragm 53 and the second backplate 59. Perforated plate 95 has perforation holes 56 such that acoustic signals can pass through the perforation holes 56 to impinge onto the diaphragm 53.

The signal conditioning electronics 80 is located at the other side of silicon substrate 51. Through wafer via 70 is used to establish electrical connection between the diaphragm 53, the first backplate 52, the second backplate 54 and signal conditioning circuit 80. Solder bumps 60 are attached to the perforated plate 95 for mounting the monolithic silicon microphone 50 according to the second preferred embodiment of the present invention.

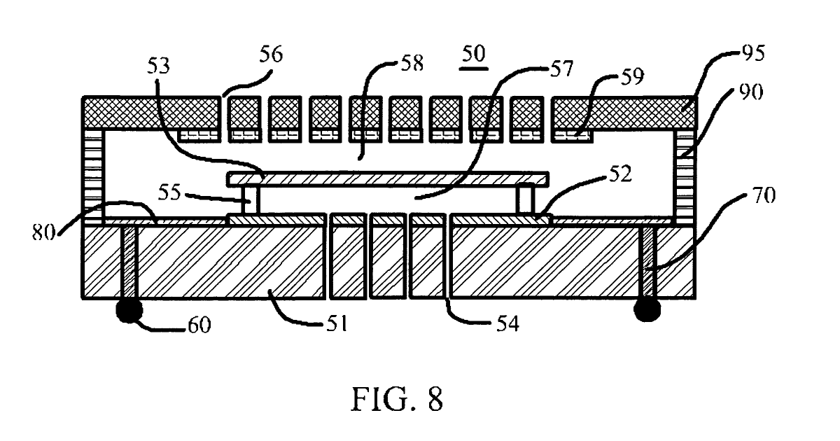

In the third preferred embodiment according to the present invention, as shown in FIG. 8, the monolithic silicon microphone 50 has silicon substrate 51. A first backplate 52 is on and supported by said silicon substrate 51. A diaphragm 53 is suspended on top of said first backplate 52, and keeps a predetermined separation from said first backplate 52 by using supports 55. Diaphragm 53 and first backplate 52 forms a cavity 57. Both substrate 51 and first backplate 52 have perforation holes 54.

The substrate 51 also supports spacers 90, which themselves support a perforated plate 95. The perforated plate 95 is itself non-conductive, but it has a second backplate 59 on one of its sides. The spacers 90 keep the perforated plate 95 a predetermined separation from the diaphragm 53 such that the separation of diaphragm 53 from the first backplate 52 is similar to the separation of diaphragm 53 from the second backplate 59. A second cavity 58 is thus formed between the diaphragm 53 and the second backplate 59. Perforated plate 95 has perforation holes 56 such that acoustic signals can pass through the perforation holes 56 to impinge onto the diaphragm 53.

The signal conditioning electronics 80 is located at the same side of silicon substrate 51 where the silicon sensing elements are. Solder bumps 60 are attached to the other surface of silicon substrate 51 for the mounting of monolithic silicon microphone 50 according to the third preferred embodiment of the present invention. Through wafer via 70 is used to establish electrical connection between the solder bumps 60 and signal conditioning circuit 80.

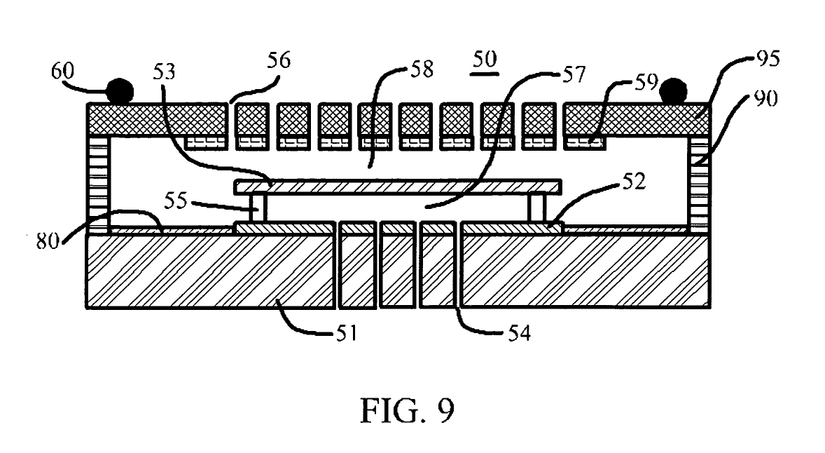

In the fourth preferred embodiment according to the present invention, as shown in FIG. 9, the monolithic silicon microphone 50 has silicon substrate 51. A first backplate 52 is on and supported by said silicon substrate 51. A diaphragm 53 is suspended on top of said first backplate 52, and keeps a predetermined separation from said first backplate 52 by using supports 55. Diaphragm 53 and first backplate 52 forms a cavity 57. Both substrate 51 and first backplate 52 have perforation holes 54.

The substrate 51 also supports spacers 90, which themselves support a perforated plate 95. The perforated plate 95 is itself non-conductive, but it has a second backplate 59 on one of its sides. The spacers 90 keep the perforated plate 95 a predetermined separation from the diaphragm 53 such that the separation of diaphragm 53 from the first backplate 52 is similar to the separation of diaphragm 53 from the second backplate 59. A second cavity 58 is thus formed between the diaphragm 53 and the second backplate 59. Perforated plate 95 has perforation holes 56 such that acoustic signals can pass through the perforation holes 56 to impinge onto the diaphragm 53.

The signal conditioning electronics 80 is located at the same side of silicon substrate 51 where the silicon sensing elements are. Solder bumps 60 are attached to the perforated plate 95 for mounting the monolithic silicon microphone 50 according to the fourth preferred embodiment of the present invention.

The foregoing descriptions of specific embodiments of the present invention are presented for the purposes of illustration and description. They are not intended to be exhaustive or to limit the invention to the precise forms disclosed; obviously many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated. It is intended that the scope of the invention be defined by the following claims and their equivalents.

What is claimed is:

1. A monolithic silicon microphone including
a first backplate supported by a silicon substrate;
a second backplate attached to a perforated plate;
a diaphragm displaced between said first backplate and said second backplate, and is supported by said first backplate; and
a signal condition circuit monolithically integrated on said substrate.

2. A monolithic silicon microphone as in claim 1 in which the said substrate has one or more perforation holes.

3. A monolithic silicon microphone as in claim 1 in which the said perforated plate is supported by the spacers on said substrate, and has one or more perforation holes.

4. A monolithic silicon microphone as in claim 1 in which the said substrate has through wafer via for electrical connection.

5. A monolithic silicon microphone as in claim 1 has solder bumps for surface mounting.

6. A monolithic silicon microphone including
a first backplate supported by a silicon substrate;
a second backplate attached to a perforated plate;
a diaphragm displaced between said first backplate and said second backplate, and is supported by said first backplate;
a signal condition circuit monolithically integrated on said substrate; and
said diaphragm, said first backplate, said second backplate and said signal conditioning circuit are electrically interconnected.

7. A monolithic silicon microphone as in claim 6 in which the said substrate has one or more perforation holes.

8. A monolithic silicon microphone as in claim 6 in which the said perforated plate is supported by the spacers on said substrate, and has one or more perforation holes.

9. A monolithic silicon microphone as in claim 6 in which the said substrate has through wafer via for electrical connection.

10. A monolithic silicon microphone as in claim 6 has solder bumps for surface mounting.

11. The method of operating a monolithic silicon microphone including
a first backplate supported by a silicon substrate;
a second backplate attached to a perforated plate;
a diaphragm displaced between said first backplate and said second backplate, and is supported by said first backplate;
a signal condition circuit monolithically integrated on said substrate; and
connecting said diaphragm and said first backplate to first input pair of said signal condition circuit;
connecting said diaphragm and said second backplate to second input pair of said signal condition circuit; and
amplifying the signals using differential amplifiers.

12. A monolithic silicon microphone as in claim 11 in which the said substrate has one or more perforation holes.

13. A monolithic silicon microphone as in claim 11 in which the said perforated plate is supported by the spacers on said substrate, and has one or more perforation holes.

14. A monolithic silicon microphone as in claim 11 in which the said substrate has through wafer via for electrical connection.

15. A monolithic silicon microphone as in claim 11 has solder bumps for surface mounting.
